(19) United States
(12) Patent Application Publication
(10) Pub. No.: US 2024/0240720 A1
(43) Pub. Date: Jul. 18, 2024

(54) VALVE DEVICE

(71) Applicant: FUJIKIN INCORPORATED, Osaka (JP)

(72) Inventors: Kazunari WATANABE, Osaka (JP); Tomohiro NAKATA, Osaka (JP); Tsutomu SHINOHARA, Osaka (JP)

(73) Assignee: FUJIKIN INCORPORATED, Osaka (JP)

(21) Appl. No.: 18/575,885

(22) PCT Filed: May 12, 2022
(86) PCT No.: PCT/JP2022/020127

§ 371 Date: Jan. 2, 2024

(30) Foreign Application Priority Data
Jul. 30, 2021 (JP) 2021-125167

(51) Int. Cl. F16K 7/17; F16K 31/122

(52) U.S. Cl. CPC F16K 7/17; F16K 31/1221

(57) ABSTRACT

A valve device includes: a flow path block in which a fluid inflow path and a fluid outflow path are formed; a diaphragm configured to open and close between the fluid inflow path and the fluid outflow path; and an actuator including a case, a piston accommodated in the case and having an air flow path formed therein, a stem configured to move the diaphragm to an open position or a closed position by moving integrally with the piston in an axial direction, an air introduction chamber surrounded by the case and the piston, and a one-touch joint configured to supply an air fluid to the air introduction chamber via the air flow path. The one-touch joint is coupled to the piston.

### TECHNICAL FIELD

The present invention relates to a valve device.

### BACKGROUND ART

JP2012-26544A discloses a valve device including: a flow path block in which a flow path is formed; a valve body configured to open and close the flow path; and an actuator including a case, a piston accommodated in the case, a stem configured to move the valve body to an open position or a closed position by moving integrally with the piston in an axial direction, and a one-touch joint attached to a top wall of the case and configured to supply driving air to the piston.

### SUMMARY OF INVENTION

However, in the valve device described in JP2012-26544A, since a pressure of the driving air supplied between the joint and the piston when the piston moves in a direction away from the flow path block acts downward at an upper end of the piston, there is a concern that an upward movement of the piston is obstructed. In particular, in a small-sized valve device, a bad influence due to the pressure of the driving air supplied between the joint and the piston when the piston moves in the direction away from the flow path block becomes remarkable.

The present invention has been made in view of this problem, and an object thereof is to provide a valve device capable of reducing a bad influence due to a pressure of a driving fluid supplied between a joint and a piston when the piston moves in a direction away from a flow path block.

According to an aspect of the present invention, a valve device comprising: a flow path block in which a flow path is formed; a valve body configured to open and close the flow path; and an actuator including a case, a piston accommodated in the case and having a fluid flow path formed therein, a stem configured to move the valve body to an open position or a closed position by moving integrally with the piston in an axial direction, a fluid introduction chamber surrounded by the case and the piston, and a joint configured to supply a driving fluid to the fluid introduction chamber via the fluid flow path, wherein the joint is coupled to the piston.

According to this aspect, it is possible to reduce the bad influence due to the pressure of the driving fluid supplied between the joint and the piston when the piston moves in the direction away from the flow path block.

### BRIEF DESCRIPTION OF DRAWINGS

FIG. 1 is a cross-sectional view showing a valve device according to an embodiment of the present invention.

### DESCRIPTION OF EMBODIMENTS

Hereinafter, an embodiment of the present invention (hereinafter, referred to as the present embodiment) will be described with reference to the accompanying drawings. In the present description, the same elements are denoted by the same reference numerals throughout the drawings.

### (Configuration of Valve Device)

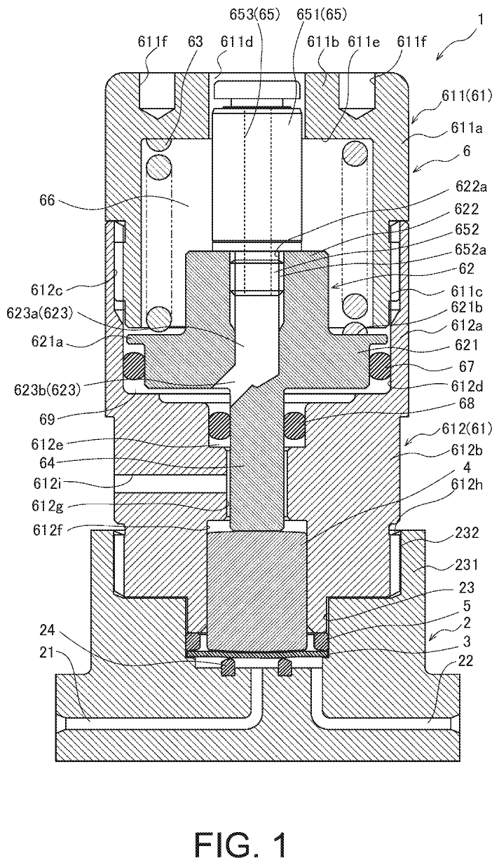

First, a valve device 1 according to the present embodiment will be described with reference to FIG. 1. FIG. 1 is a cross-sectional view showing the valve device 1. In FIG. 1, a one-touch joint 65 is shown in a non-sectional view.

The valve device 1 according to the present embodiment is provided in a fluid control apparatus (not shown) used for manufacturing a semiconductor. The fluid control apparatus is used in a thin film forming step of forming a predetermined thin film on a substrate such as a semiconductor wafer by an atomic layer deposition (ALD) method.

As shown in FIG. 1, the valve device 1 includes a flow path block 2, a diaphragm 3 as a valve body, a diaphragm presser 4 as a valve body presser, a spacer 5, and an actuator 6. The valve device 1 is an air operated valve that allows the diaphragm 3 to open and close by supplying driving air as a driving fluid to the actuator 6.

The flow path block 2 includes a fluid inflow path 21 and a fluid outflow path 22 as flow paths, and a recess 23 in which a bonnet 612 of a case 61 (described later) constituting the actuator 6 is accommodated.

An upper end as one end of the fluid inflow path 21 and an upper end as one end of the fluid outflow path 22 communicate with each other via the recess 23. An annular valve seat 24 is provided at a peripheral edge of one end of the fluid inflow path 21. The flow path block 2 includes a peripheral wall 231 that forms the recess 23. A female screw 232 to be screwed into the bonnet 612 is formed on an inner peripheral surface of the peripheral wall 231.

The diaphragm 3 is a sheet-shaped valve body that opens the fluid inflow path 21 by being separated from the valve seat 24 or closes the fluid inflow path 21 by being pressed against the valve seat 24. The diaphragm 3 is a diaphragm member for separating a flow path side and an actuator 6 side. In addition, the diaphragm 3 is formed in an arc shape protruding toward the actuator 6 side (upper side in FIG. 1) in a natural state, and is made of, for example, a nickel alloy thin plate. Generally, the diaphragm 3 is pressed against the valve seat 24 by the diaphragm presser 4.

The diaphragm presser 4 is a columnar pressing member for pressing the diaphragm 3 against the valve seat 24. The diaphragm presser 4 is accommodated in the bonnet 612. An upper end as one end of the diaphragm presser 4 is abutted against a stem 64 (described later) constituting the actuator 6, and a lower end as the other end of the diaphragm presser 4 faces the diaphragm 3.

The spacer 5 is an annular pressing adapter for pressing an outer peripheral edge of the diaphragm 3. The spacer 5 is provided between a bottom surface of the recess 23 of the flow path block 2 and a lower end of the bonnet 612. The outer peripheral edge of the diaphragm 3 is held between the spacer 5 and the bottom surface of the recess 23, and is fixed by screwing the bonnet 612 into the female screw 232 of the peripheral wall 231. The lower end of the diaphragm presser 4 that comes into contact with the diaphragm 3 is inserted into an inner peripheral side of the spacer 5.

The actuator 6 blocks the fluid inflow path 21 and the fluid outflow path 22 by pressing the diaphragm 3 against the valve seat 24 via the diaphragm presser 4 accommodated in a second accommodating chamber 612f (described later) of the bonnet 612, or allows the fluid inflow path 21 to communicate with the fluid outflow path 22 by separating the diaphragm 3 from the valve seat 24 via the diaphragm presser 4. The actuator 6 includes the case 61, a piston 62, a coil spring 63, the stem 64, and the one-touch joint 65 as a joint. In the present embodiment, the stem 64 is described as a component different from the piston 62, but the stem 64 is not limited to this, and may be a part of the piston 62, for example.

The case 61 is a frame member for accommodating the piston 62, the coil spring 63, the stem 64, and the one-touch joint 65. The case 61 is provided above the flow path block 2. In addition, the case 61 includes a substantially cylindrical cap 611 having a bottom as an upper case, and the bonnet 612 as a lower case coupled to the cap 611 by screwing.

The cap 611 includes a cylindrical peripheral wall 611a and a circular plate-shaped top wall 611b provided at an upper end as one end of the peripheral wall 611a.

A male screw 611c to be screwed into the bonnet 612 is formed on an outer peripheral surface on a lower end side as the other end side of the peripheral wall 611a. A through hole 611d penetrating in an axial direction of the stem 64 (an up-down direction in FIG. 1) is formed at a center of the top wall 611b as one end of the case 61. A flexible tube (not shown) for coupling a driving air supply controller (not shown) and the one-touch joint 65 is inserted into the through hole 611d.

An annular surface 611e as a holding surface that holds an upper end as one end of the coil spring 63 is formed on the top wall 611b so as to surround the through hole 611d. The coil spring 63 is accommodated in a spring accommodating space 66 formed between the annular surface 611e and the piston 62 in a compressed state such that the upper end of the coil spring 63 abuts against the annular surface 611e and a lower end as the other end of the coil spring 63 abuts against the piston 62.

A pair of engagement holes 611f with which rotating jigs for rotating the cap 611 are engaged are formed in the top wall 611b so as not to interfere with the through hole 611d.

The bonnet 612 is coupled to both the cap 611 and the flow path block 2 by screwing. The bonnet 612 includes a cylindrical peripheral wall 612a and a bonnet main body 612b provided below the peripheral wall 612a.

A female screw 612c to be screwed into the male screw 611c is formed on an inner peripheral surface on an upper end side as one end side of the peripheral wall 612a. An abutting surface 612d, against which an outer peripheral surface of an O-ring 67 as a first sealing member abuts, is formed on an inner peripheral surface on a lower end side as the other end side of the peripheral wall 612a.

A first accommodating chamber 612e that accommodates an O-ring 68 as a second sealing member is formed in a central portion of an upper end as one end of the bonnet main body 612b. In a state where the O-ring 68 is accommodated in the first accommodating chamber 612e, an inner peripheral surface of the first accommodating chamber 612e abuts against an outer peripheral surface of the O-ring 68. The second accommodating chamber 612f that accommodates the diaphragm presser 4 is formed in a central portion of a lower end as the other end of the bonnet main body 612b. An insertion hole 612g through which the first accommodating chamber 612e and the second accommodating chamber 612f communicate with each other and the stem 64 is inserted is formed in the bonnet main body 612b.

In addition, a male screw 612h to be screwed into the female screw 232 of the peripheral wall 231 is provided on an outer peripheral surface on a lower end side of the bonnet main body 612b. Further, an air vent hole 612i that allows the insertion hole 612g to communicate with the outside is formed in the bonnet main body 612b along a radial direction of the stem 64.

The piston 62 includes a circular plate-shaped piston main body 621, a coupling portion 622 provided at an upper end as one end of the piston main body 621, and an air flow path 623 as a fluid flow path formed in the coupling portion 622 and the piston main body 621.

An outer peripheral surface as a sliding contact surface of the piston main body 621 comes into sliding contact with an inner peripheral surface of the O-ring 67. An annular flange 621a protruding from the outer peripheral surface of the piston main body 621 is provided on an upper end side of the piston main body 621. The O-ring 67 is accommodated between the flange 621a and an upper end surface of the bonnet main body 612b.

The tubular (specifically, cylindrical) coupling portion 622 protruding from an upper end surface as one end surface of the piston main body 621 is provided at a central portion of the upper end surface of the piston main body 621. An annular surface 621b as a holding surface that holds the lower end of the coil spring 63 is formed on the upper end surface of the piston main body 621 so as to surround the coupling portion 622. A female screw 622a to be screwed into a male screw 652a (described later) of the one-touch joint 65 is formed on an inner peripheral surface of the coupling portion 622.

The air flow path 623 is a flow path through which the driving air is introduced into an air introduction chamber 69 as a fluid introduction chamber described later. The air flow path 623 includes an axial flow path 623a formed in the coupling portion 622 and the piston main body 621 so as to extend along the up-down direction (that is, the axial direction of the stem 64), and a communication flow path 623b formed in the piston main body 621 and the stem 64 so as to allow the axial flow path 623a to communicate with the air introduction chamber 69.

The axial flow path 623a is connected to a lower end of the female screw 622a, and is formed such that a tip end thereof enters the piston main body 621. The communication flow path 623b is formed to be inclined with respect to the axial direction of the stem 64 so as to allow the tip end of the axial flow path 623a to communicate with the air introduction chamber 69.

The stem 64 is a stem that moves the diaphragm 3 to an open position or a closed position via the diaphragm presser 4 by moving integrally with the piston 62 in the axial direction. The stem 64 protruding from a lower end surface as the other end surface of the piston main body 621 is provided at a central portion of the lower end surface of the piston main body 621. In the present embodiment, the stem 64 is formed integrally with the piston 62, but the stem 64 is not limited to this, and may be formed separately from the piston 62, for example.

The stem 64 is formed to be inserted through the first accommodating chamber 612e and the insertion hole 612g in this order, and a tip end thereof enters the second accommodating chamber 612f. An outer peripheral surface as a sliding contact surface of the stem 64 comes into sliding contact with an inner peripheral surface of the O-ring 68. The diaphragm presser 4 abuts against the tip end of the stem 64. Accordingly, the diaphragm presser 4 can move integrally with the stem 64 in the axial direction.

The air introduction chamber 69 is a region surrounded by the bonnet 612, the piston main body 621, the stem 64, the O-ring 67, and the O-ring 68.

The one-touch joint 65 is a joint for coupling the flexible tube to the coupling portion 622 of the piston 62. The one-touch joint 65 is coupled to the coupling portion 622 of the piston 62. Accordingly, it is not necessary to provide a coupling structure for coupling the one-touch joint 65 to the cap 611 of the case 61. Therefore, a structure of the cap 611 can be simplified.

In addition, the one-touch joint 65 includes a tubular (specifically, cylindrical) joint main body 651, a tubular (specifically, cylindrical) screwing portion 652 provided at a lower end as the other end of the joint main body 651, and a joint flow path 653 formed on inner peripheral sides of the joint main body 651 and the screwing portion 652. The male screw 652a to be screwed into the female screw 622a of the coupling portion 622 is formed on an outer peripheral surface of the screwing portion 652. An outer diameter of the screwing portion 652 is smaller than an outer diameter of the joint main body 651. Both ends of the joint flow path 653 communicate with a flow path of the flexible tube and the air flow path 623 (specifically, the axial flow path 623a) of the piston 62, respectively.

A coupling position between an upper end as one end of the joint main body 651 and a tip end of the flexible tube is sealed. Then, by screwing the male screw 652a of the screwing portion 652 into the female screw 622a of the coupling portion 622, the one-touch joint 65 is coupled to the coupling portion 622 of the piston 62. Accordingly, a gap present between the one-touch joint 65 and the piston 62 can be eliminated. Therefore, it is possible to reduce a bad influence due to a pressure of the driving air supplied between the one-touch joint 65 and the piston 62 when the piston 62 is separated from the flow path block 2 and moves upward.

In addition, it is not necessary to seal between the piston 62 and the cap 611 and between the through hole 611d of the cap 611 and the one-touch joint 65, and it is possible to eliminate structures (specifically, including an O-ring) that seal between the tip end of the piston 62 and the cap 611 and between the through hole 611d and the one-touch joint 65. As a result, the structure of the cap 611 can be further simplified.

Further, it is preferable that an annular (circular ring-shaped) sealing member is provided on an annular surface (circular ring-shaped surface) of the lower end of the joint main body 651 located on an outer peripheral side of the screwing portion 652. Accordingly, in a state where the one-touch joint 65 and the coupling portion 622 of the piston 62 are coupled to each other by the screwing between the male screw 652a and the female screw 622a, it is possible to seal the coupling position between the lower end of the joint main body 651 and the tip end of the coupling portion 622 by abutting the sealing member against a tip end surface of the coupling portion 622.

In the present embodiment, the one-touch joint 65 is coupled to the coupling portion 622 of the piston 62 by the screwing between the male screw 652a and the female screw 622a, but the one-touch joint 65 is not limited to this, and may be coupled to the coupling portion 622 of the piston 62 by, for example, fitting or adhesion.

The outer diameter of the joint main body 651 is smaller than an inner diameter of the through hole 611d. That is, a clearance is formed between an outer peripheral surface of the joint main body 651 and an inner peripheral surface of the through hole 611d. Accordingly, the one-touch joint 65 enters the through hole 611d when moving integrally with the piston 62 and the stem 64 in the axial direction, but does not come into sliding contact with the through hole 611d. Therefore, it is possible to reduce sliding contact resistance due to the sliding contact between the one-touch joint 65 and the through hole 611d. As a result, responsiveness of the actuator 6 can be improved. That is, a time for opening or closing the diaphragm 3 can be shortened.

The clearance allows the spring accommodating space 66 that accommodates the coil spring 63 to communicate with the outside. Accordingly, it is not necessary to form an air vent hole that allows the spring accommodating space 66 to communicate with the outside. Therefore, the structure of the cap 611 can be further simplified.

The joint main body 651 does not protrude from the top wall 611b of the cap 611 when moving integrally with the piston 62 and the stem 64 in the axial direction. Accordingly, compared to a valve device in which the one-touch joint 65 is attached to the top wall 611b of the case 61 so as to protrude from the case 61, a size of the valve device 1 in the axial direction can be reduced.

### (Operation of Valve Device)

Next, an operation of the valve device 1 will be described.

When the driving air supply controller supplies driving air to the actuator 6 of the valve device 1, the driving air is introduced into the air introduction chamber 69 via the flexible tube, the joint flow path 653 of the one-touch joint 65, and the air flow path 623 of the piston 62 in this order.

Accordingly, the piston 62 moves upward integrally with the one-touch joint 65 and the stem 64 against a biasing force of the coil spring 63 such that a volume of the air introduction chamber 69 increases. The diaphragm 3 then rises together with the diaphragm presser 4 due to a restoring force thereof, thereby separating from the valve seat 24. That is, the diaphragm 3 opens the fluid inflow path 21 by the rising of the piston 62, the one-touch joint 65, the stem 64, and the diaphragm presser 4. Therefore, a fluid such as a vaporized process gas is supplied from the fluid inflow path 21 to the fluid outflow path 22 through a gap formed between the valve seat 24 and the diaphragm 3.

On the other hand, when the driving air supply controller does not supply driving air to the actuator 6 of the valve device 1, the piston 62 moves downward integrally with the stem 64 by the biasing force of the coil spring 63. The diaphragm 3 is then pressed against the valve seat 24 via the diaphragm presser 4 by the downward movement of the stem 64. That is, the diaphragm 3 closes the fluid inflow path 21 by the movement of the piston 62, the one-touch joint 65, the stem 64, and the diaphragm presser 4. Therefore, a fluid such as a vaporized process gas is not supplied from the fluid inflow path 21 to the fluid outflow path 22.

The volume of the air introduction chamber 69 decreases by the movement of the piston 62, the one-touch joint 65, the stem 64, and the diaphragm presser 4. At this time, air in the air introduction chamber 69 is led out to the driving air supply controller via the air flow path 623, the joint flow path 653, and the flexible tube in this order.

In this way, the driving air supply controller can switch the opening and closing of the diaphragm 3 with respect to the valve seat 24 by controlling the supply of the driving air to the actuator 6 of the valve device 1. Therefore, according to such a valve device 1, it is possible to control the fluid supply from the fluid inflow path 21 to the fluid outflow path 22. In the present embodiment, the valve device 1 is a normally closed valve device, but the valve device 1 is not limited to this, and may be a normally open valve device, for example.

### Functions and Effects

Next, main functions and effects of the present embodiment will be described.

The valve device 1 according to the present embodiment includes: the flow path block 2 in which the fluid inflow path 21 and the fluid outflow path 22 are formed; the diaphragm 3 configured to open and close between the fluid inflow path 21 and the fluid outflow path 22; and the actuator 6 including the case 61, the piston 62 accommodated in the case 61 and having the air flow path 623 formed therein, the stem 64 configured to move the diaphragm 3 to an open position or a closed position by moving integrally with the piston 62 in an axial direction, the air introduction chamber 69 surrounded by the case 61 and the piston 62, and the one-touch joint 65 configured to supply an air fluid to the air introduction chamber 69 via the air flow path 623. The one-touch joint 65 is coupled to the piston 62.

According to this configuration, a gap present between the one-touch joint 65 and the piston 62 can be eliminated. Therefore, it is possible to reduce a bad influence due to a pressure of the driving air supplied between the one-touch joint 65 and the piston 62 when the piston 62 moves in a direction away from the flow path block 2.

In addition, it is not necessary to seal between the piston 62 and the cap 611 and between the cap 611 and the one-touch joint 65, and it is possible to eliminate structures (specifically, including an O-ring) that seal between the tip end of the piston 62 and the cap 611 and between the cap 611 and the one-touch joint 65. As a result, the structure of the cap 611 constituting the case 61 can be further simplified.

In the present embodiment, the one-touch joint 65 does not come into sliding contact with the case 61 when moving integrally with the piston 62 and the stem 64 in the axial direction.

In addition, in the present embodiment, the through hole 611d is formed at the top wall 611b of the cap 611 as one end on a side opposite to the flow path block 2 of the case 61, and a clearance is formed between an outer peripheral surface of the one-touch joint 65 and an inner peripheral surface of the through hole 611d.

According to this configuration, the one-touch joint 65 enters the through hole 611d when moving integrally with the piston 62 and the stem 64 in the axial direction, but does not come into sliding contact with the through hole 611d. Therefore, it is possible to reduce sliding contact resistance due to the sliding contact between the one-touch joint 65 and the through hole 611d. As a result, responsiveness of the actuator 6 can be improved.

In addition, in the present embodiment, the one-touch joint 65 does not protrude from the case 61 when moving integrally with the piston 62 and the stem 64 in the axial direction.

According to this configuration, compared to a valve device in which the one-touch joint 65 is attached to the top wall 611b of the case 61 so as to protrude from the case 61, a size of the valve device 1 in the axial direction can be reduced.

In addition, in the present embodiment, the case 61 includes the cap 611 and the bonnet 612 coupled to both the cap 611 and the flow path block 2, and the stem 64 is entirely accommodated in the bonnet 612.

According to this configuration, by coupling the bonnet 612 coupled to the flow path block 2, as a lower case constituting the case 61, to the cap 611 as an upper case constituting the case 61, the lower case and the bonnet 612 can be integrated with each other. Therefore, parts constituting the valve device 1 can be simplified.

In addition, since the stem 64 is entirely accommodated in the bonnet 612, the size of the valve device 1 in the axial direction can be further reduced. In addition, in the valve device 1 whose size is reduced, a bad influence that has become noticeable due to the pressure of the driving air supplied between the one-touch joint 65 and the piston 62 when the piston 62 moves in a direction away from the flow path block 2 can be reduced.

Although the present embodiment has been described above, the above-mentioned embodiment is merely a part of application examples of the present invention, and does not mean that the technical scope of the present invention is limited to the specific configurations of the above-mentioned embodiment.

The present application claims priority under Japanese Patent Application No. 2021-125167 filed to the Japan Patent Office on Jul. 30, 2021, and the entire content of this application is incorporated herein by reference.

### DESCRIPTION OF REFERENCE SIGNS

1 valve device
2 flow path block
3 diaphragm (valve body)
6 actuator
21 fluid inflow path (flow path)
22 fluid outflow path (flow path)
61 case
62 piston
64 stem
65 one-touch joint (joint)
69 air introduction chamber (fluid introduction chamber)
611 cap
612 bonnet
611d through hole
623 air flow path (fluid flow path)

1. A valve device comprising:
a flow path block in which a flow path is formed;
a valve body configured to open and close the flow path; and
an actuator including a case, a piston accommodated in the case and having a fluid flow path formed therein, a stem configured to move the valve body to an open position or a closed position by moving integrally with the piston in an axial direction, a fluid introduction chamber surrounded by the case and the piston, and a joint configured to supply a driving fluid to the fluid introduction chamber via the fluid flow path, wherein
the joint is coupled to the piston.

2. The valve device according to claim 1, wherein
the joint does not come into sliding contact with the case when moving integrally with the piston and the stem in the axial direction.

3. The valve device according to claim 2, wherein
a through hole is formed at one end of the case, and
a clearance is formed between an outer peripheral surface of the joint and an inner peripheral surface of the through hole.

4. The valve device according to claim 1, wherein
the joint does not protrude from the case when moving integrally with the piston and the stem in the axial direction.

5. The valve device according to claim 1, wherein
the case includes a cap and a bonnet coupled to both the cap and the flow path block, and
the stem is entirely accommodated in the bonnet.
